(19) United States
(12) Patent Application Publication
(10) Pub. No.: US 2005/0098101 A1
(43) Pub. Date: May 12, 2005

(54) Apparatus for manufacturing fuel cell membrane electrode assembly

(75) Inventors: John Jianyue Shen, Delta (CA); Zuomin Dong, Victoria (CA); Yu Liu, Vancouver (CA)

Correspondence Address: TROUTMAN SANDERS LLP, BANK OF AMERICA PLAZA, SUITE 5200, 600 PEACHTREE STREET , NE, ATLANTA, GA, 30308-2216, US

(73) Assignee: Palcan Power Systems Inc., Burnaby (CA)

(21) Appl. No.: 10/981,404

(22) Filed: Nov. 4, 2004

Related U.S. Application Data
(60) Provisional application No. 60/516,765, filed on Nov. 4, 2003.

(51) Int. Cl. B05C 5/00; B05B 7/06

(52) U.S. Cl. 118/696; 118/313; 118/704

(57) ABSTRACT

An apparatus is provided for manufacturing one or more fuel cell membrane electrode assembly (MEA) components. The apparatus has a table for supporting one or more MEA components; a motorized arm assembly movable relative to the table; an ultrasonic sprayer assembly connected to the arm assembly and in fluid communication with at least one ink reservoir containing catalyst or electrolyte ink solution; and a controller communicative with the arm and sprayer assemblies and programmable to move the arm assembly along a programmed tool path and spray ink solution from the sprayer assembly onto a substrate supported by the table.

### RELATED US APPLICATION DATA

This application claims priority from U.S. Provisional Application No. 60/516,765 filed 4 Nov. 2003.

### FIELD OF THE INVENTION

This invention relates generally to an apparatus for manufacturing a fuel cell membrane electrode assembly, especially for proton exchange membrane (PEM) type fuel cells.

### BACKGROUND ART OF THE INVENTION

A fuel cell electrochemically converts a fuel and an oxidant to electricity and a reaction product. In fuel cells employing hydrogen as the fuel and oxygen as the oxidant, the reaction product is water.

A solid polymer PEM type fuel cell typically comprises a membrane electrode assembly (MEA) sandwiched between a pair of separator plates. As shown in FIG. 1, a conventional PEM fuel cell MEA consists of a solid polymer PEM 1 disposed between a pair of catalyzed electrodes. The MEA is a key component of the PEM fuel cell since it is the location where H₂ (or other suitable fuel such as methanol) and O₂ in the reactant air react electrochemically to generate electric power. The PEM 1 serves as an electrolyte and separates the electrodes to prevent reactants mixing and the formation of an electrical shortage. Typical PEM such as Nafion® 112 is made of a perfluorinated polymer with side chains bearing sulfonic acid moieties. Each of the two electrodes consist of a gas diffusion layer (GDL) 3 coated with a Pt-based electrocatalyst layer 2 located between the PEM 1 and the GDL 3. Platinum based electrocatalysts are amongst the most active materials for oxygen reduction and hydrogen or methanol oxidation. These electrocatalysts have sufficient stability to operate in the acidic environment of the PEM fuel cell. To avoid CO poisoning from a hydrogen supply gas stream produced by a reformer or generated during the oxidation of methanol, platinum-ruthenium (Pt-Ru) alloys can be used as electrocatalyst material. However, these rare metal electrocatalyst materials lead to considerable high cost of the MEA and the fuel cell, presenting a major obstacle to the commercialization of PEM fuel cell.

Extensive research has been carried out to identify techniques that can reduce the amount of electrocatalyst loading (to around 0.1 to 0.4 mgPt/cm²) while still achieving suitable PEM fuel cell performance. Known techniques involve attaching fine electrocatalyst alloy particles (10 μm) to larger carbon particles (40 μm). These electrocatalyst-loaded carbon powders are dissolved in a solvent and painted onto the GDL by hand or by screen-printing. During this process, multiple paint layers are often applied to increase the exposure of the electrocatalyst material in the depth direction. An ionomeric polymer layer, such as Nafion®, is often applied by painting or spraying between each successive catalyst layer to facilitate the formation of a 3-phase region and to achieve better fuel cell performance.

MEA Performance Influencing Factors

The performance of the MEA is related mainly to the structure of the catalytic layer. The fuel and the oxidant have to reach the catalytic particles in order for the reaction to take place. Improving the characteristics of the catalytic layer is currently a major objective of fuel cell research and development since such characteristics directly relate to the performance and cost of the fuel cell. It is generally known that in order to optimize the catalytic layer characteristics, several parameters must be controlled, including:

1) Catalytic Layer Thickness

The thickness of the catalytic layer should be selected to control over-potential of the catalytic layers; state of the art understanding generally recommends catalytic layers having a thickness in the range of 10 microns.

2) Catalytic Layer Evenness

Catalytic layer evenness is directly correlated with the extent of power generated by the MEA and should be as even as possible to maximize electric contact with the MEA.

3) Amount of Catalyst Loading

The amount of loaded catalyst is directly related to the total cost of the MEA and fuel cell. For practical reasons, as little loading as possible is desired that maintains stable power generation performance of the MEA within the designed life of the fuel cell.

4) Porosity of the Catalytic Layer

Access of the gases to the catalytic particles is dictated by the porosity of the catalytic layer. The higher the porosity, the better access of the gases is obtained. Appropriate porosity also facilitates the propelling of by-product water for efficient fuel cell water management.

5) Interface between PEM and GDL

Improved fuel cell performance can be achieved by providing a seamless interface between the PEM and GDL. The interface should also provide a catalytic layer with good exposure of the electrocatalyst material therein, sufficient depth, and a three-phase region of ionomeric polymer, catalyst and porous carbon.

6) Hydrophobic GDL

The GDL should have sufficient hydrophobic properties to effectively remove by-product water and to avoid flooding in the electrodes; known GDLs are often treated using Teflon®.

Many methods for applying catalyst material onto porous GDL electrode substrates and/or the solid PEM electrolytes have been studied. These include chemical vapor deposition, direct application by electrostatically-charged power attraction, or application through a copying drum by electrostatically-charged power attraction. Various methods for applying catalyst material onto carbon paper/cloth GDL electrode substrates have also been reported. These include hand painting, ink spraying, paste rolling, edge printing and screen printing. These processes use an ink or paste which normally comprise an ink binder and an ink solid. The ink solid typically comprises relatively large carbon/graphite particles that are coated with smaller catalyst particles to retain a high active contact surface area of the catalyst for better performance with a reduced amount of catalyst metal for lower cost.

These known methods are primarily in the research and development phase and are not suitable for commercial use as they do not sufficiently reduce manufacturing costs to make fuel cells commercially viable, nor enable mass-manufacturing of fuel cells that have sufficiently consistent quality and performance for commercial use.

### SUMMARY OF THE INVENTION

It is an object of the invention to provide an apparatus and process for manufacturing the MEA of fuel cells, which is an improvement over current MEA processing techniques. In particular, it is desirable to provide an automated, quality, and cost effective MEA production process and apparatus that facilitates the formation of quality MEA structures, leading to improved fuel cell performance.

According to one aspect of the invention, there is provided an apparatus for manufacturing one or more fuel cell membrane electrode assembly (MEA) components. This apparatus comprises:
(a) a table for supporting one or more MEA components;
(b) a motorized arm assembly movable relative to the table;
(c) an ultrasonic sprayer assembly connected to the arm assembly and in fluid communication with at least one ink reservoir containing catalyst or electrolyte ink solution; and
(d) a controller communicative with the arm and sprayer assemblies and programmable to move the arm assembly along a programmed tool path and spray ink solution from the sprayer assembly onto a substrate supported by the table.

The apparatus can be constructed by retrofitting the ultrasonic sprayer assembly onto a CNC machine having the table, the arm assembly and the programmable controller. A microcomputer can be provided that communicates with the CNC controller as well as with the sprayer assembly; the computer can programmed using G-code or another CNC program to move the arm assembly along a programmed tool path and to spray ink solution from the sprayer assembly onto a substrate supported by the table. The CNC machine can be a CNC router or a milling machine without the spindle and cutter portions.

The sprayer assembly can comprise multiple discharge nozzles, with each nozzle being fluidly coupled to at least one dedicated ink reservoir. Alternatively, the sprayer assembly can comprise a single discharge nozzle coupled to multiple ink reservoirs by a switching valve that is controllable to direct ink solution from one or more reservoirs to the nozzles.

The controller can be programmed to vary during the spraying process, one or more of: a spray composition, pattern, and intensity, and, one or more of the sprayer assembly location and speed over the substrate. This enables the creation of a catalytic layer having a compositionally graded structure in one of more of its dimensions that provides improved fuel cell performance.

The apparatus can include multiple ink reservoirs with a first ink reservoir containing an electro-catalyst ink solution, a second ink reservoir containing an ionomeric polymer ink solution, and a third ink reservoir containing a carbon ink solution; in such case, the controller is programmed to control the spray composition by controlling the flow of each ink solution to the sprayer assembly during the spraying process. The sprayer assembly can further comprise a pump coupled to each ink reservoir; in such case, the controller is communicative with the pump to control the spray intensity by controlling the pump's feed rate. The sprayer assembly can also have air jets; in which case the controller is communicative with the air jets to direct the air jets to shape the spray pattern. The arm assembly can include multiple tracks and arms movably coupled to the tracks such that the sprayer assembly is independently movable relative to the length, width and height of the table; in such case, the controller is communicative with the arm assembly to control the sprayer assembly location and speed over the length, width and height of substrate.

The controller can be programmed to control at least one of the spray composition, spray intensity, spray pattern, sprayer movement, and sprayer speed during spraying to form a catalytic layer having a compositionally graded depth with an increasing amount of carbon material towards a gas-diffusion layer interface portion of the catalytic layer, and/or an increasing amount of ionomeric-polymer material towards an electrolyte interface portion of the catalytic layer.

Also, the controller can be programmed to control at least one of the spray composition, spray intensity, spray pattern, sprayer movement, and sprayer speed to form a compositionally graded catalytic layer with a greater amount of electrocatalyst and/or water repellent material at a downstream end of a fuel cell flow field than at an upstream end of the fuel cell flow field.

The controller can additionally be programmed to apply multiple spray passes onto a gas diffusion layer substrate or a proton exchange membrane substrate. At least two of these spray passes spray catalytic ink solutions having different compositions, thereby creating a catalytic layer with a compositionally graded depth.

The apparatus can also include a heating element located in the vicinity of the table, for heating the substrate supported thereon, thereby shortening the drying time of the ink sprayed onto the substrate. Additionally, the apparatus can have an enclosure surrounding the arm and sprayer assemblies, for impeding diffusion of fumes emitted from the ink solution. The heating element can be located in the vicinity of the enclosure, for heating the inside of the enclosure.

### BRIEF DESCRIPTION OF THE DRAWINGS

FIG. 1 is a schematic side view of a membrane electrode assembly (MEA) of a proton exchange membrane (PEM) Fuel Cell. (PRIOR ART)

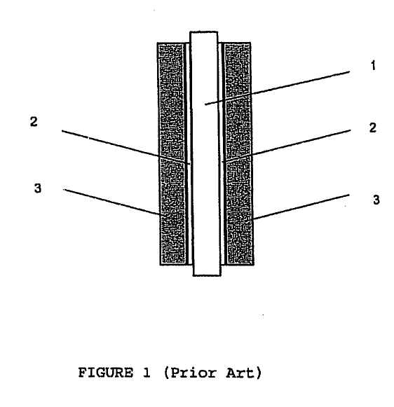

FIG. 2 is a schematic perspective view of a computer numerically controlled (CNC) ultrasonic sprayer for manufacturing PEM MEAs according to an embodiment of the invention.

FIG. 3 is a schematic perspective view of a CNC router and ultrasonic spray nozzles of the CNC ultrasonic sprayer.

FIG. 4(a) is a block diagram illustrating components of the CNC ultrasonic sprayer shown in FIG. 2; FIG. 4(b) is a block diagram illustrating an alternative single spray nozzle embodiment of the ultrasonic sprayer.

FIG. 5 is a schematic side cut-away view of an ultrasonic spray nozzle of the CNC ultrasonic sprayer.

FIGS. 6(a) and (b) are respective schematic side elevation views of a PEM layer and an electrode layer coated with catalytic material of a PEM MEA manufactured by the CNC ultrasonic sprayer.

FIG. 7 is a schematic side elevation view of an assembled MEA manufactured by the CNC ultrasonic sprayer.

FIG. 8 is a graph illustrating the performance of an MEA produced by the ultrasonic sprayer.

FIG. 9 illustrates an example of a spray nozzle path programmed in a control computer of the CNC ultrasonic sprayer.

FIG. 10 illustrates an example G-code program used to control the spray nozzle path shown in FIG. 9 and operation of the nozzle along this path.

### DETAILED DESCRIPTION OF EMBODIMENTS OF THE INVENTION

CNC Ultrasonic Sprayer

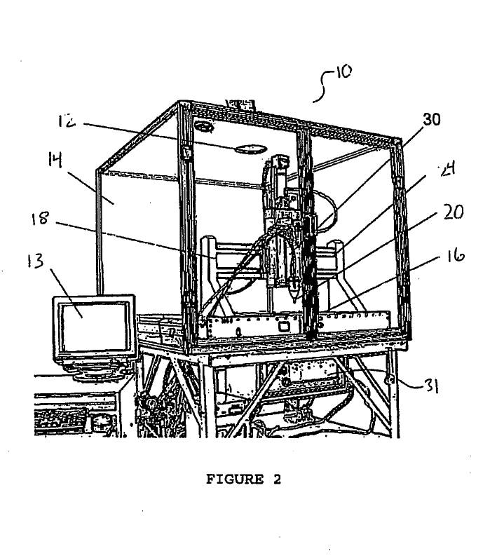

According to one embodiment of the invention, and referring to FIG. 2, a CNC ultrasonic sprayer 10 is provided for automated batch or mass manufacture of one or more components of a PEM fuel cell MEA. In particular, the sprayer 10 can be used to spray the catalytic layer 2 onto the PEM substrate 1, or to spray catalytic material onto a GDL substrate 3 to form the catalytic layer 2, and then spray electrolyte material onto the catalytic layer 2 to form the PEM electrolyte layer 1.

The sprayer 10 is located underneath a fume hood 12 which operates to remove fumes created from ink materials sprayed by the sprayer 10. A glass enclosure 14 extending from the fume hood 12 and surrounding the sprayer 10 serves to impede fumes from escaping the fume hood 12. Operation of the sprayer 10 is controlled by a programmable computer 14 communicative with the sprayer 10. The enclosed space can be heated by a heat lamp (not shown) or other suitable heat source to shorten the drying time of the sprayed substrates therein and thus improve manufacturing times and efficiencies.

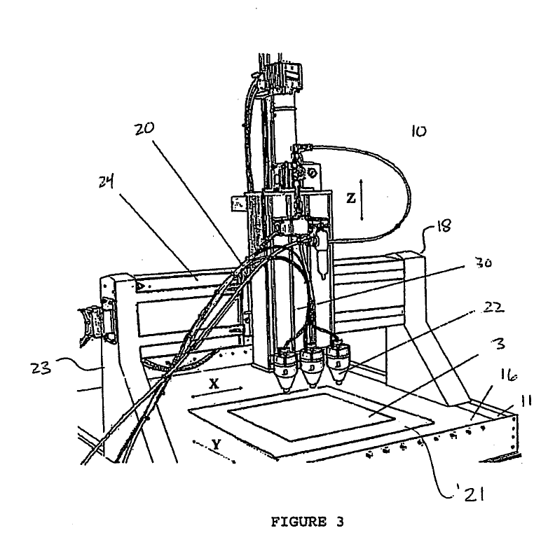

Referring to FIG. 3, the sprayer has a table 16 which serves as a work surface for supporting substrates to be sprayed by the sprayer 10. A motorized arm assembly 18 is movably mounted over the table 16, and a sprayer assembly 20 is mounted to the arm assembly 18 such that spraying nozzles 22 of the sprayer assembly 20 is pointed at the table 16. To shorten the drying time of the printed materials and to improve the efficiency of multiple layer spraying, the table 16 can be heated, or a heated pad 21 can be added under the substrate 3 and on top of the table 16.

The motorized arm assembly 18 can be the arm assembly typically found in CNC routers or milling machines, and as such, has a pair of vertical arms 23 horizontally movable along a pair of tracks 24 that extend along the outside longitudinal edges of the table 16, thereby enabling the vertical arms 23 to move along the length of the table 16. Connected to the vertical arms 23 and extending transversely across the table 16 is a horizontal arm 24 having a transverse track 26 extending transversely across the table 16. A nozzle assembly mount 30 is transversely movably mounted to the transverse track 26, thereby enabling the nozzle assembly mount 30 to move across the width of the table 16.

The nozzle assembly mount 30 has a vertical track (not shown) extending along the height of a bracket (not shown); the bracket is the portion of the nozzle assembly mount 30 that is movably mounted to the transverse track 26. The rest of nozzle assembly mount 30 is vertically movably mounted to the bracket. The sprayer assembly 20 is mounted to the nozzle assembly mount 30 and thus can be moved along three axis, namely a Y axis corresponding to the length of the table 16, an X axis corresponding to the width of the table 16, and a Z axis corresponding to the height of the table 16, via longitudinal movement of the vertical arms 22, transverse movement of the horizontal arm 24, and vertical movement of the nozzle assembly mount 30.

The relative motion of the arm assembly 18 to the PEM or GDL substrate 3 on the table 16, and the operation of the sprayer assembly 20 are controlled by the control computer 14 via the instructions of a CNC tool path program, suitably in the form of APT codes or G-codes. Controlling a machine tool using variable inputs, normally from a stored program, is known as numerical control (NC) and is well known in the art. Generally speaking, an NC system consists of three basic components: (1) a program of instructions, (2) a machine control unit (MCU), and (3) a controlled machine tool such as a router. In modern NC systems, the machine control unit (MCU) is typically a microcomputer and related control hardware that stores the program of instructions and executes it by converting each command into mechanical actions of the processing equipment, one command at a time.

The NC or CNC machine tool has a controller that receives instructions from the MCU and produces relative linear and arc motions along the three coordinate axes, X, Y, and Z. NC systems that control the three linear motions are known as 3-axis NC machines. A 2-D tool path is typically programmed using NC instructions to control the trajectory of the controlled tool in the X-Y plane. A 3-axis NC system can also control the height of the controlled tool along the Z direction, resulting in three synchronized motions. To create the required spray paths, the machine must have at least 2 and ½ controllable axes of motion, and preferably 3 fully controllable axes of motion. In a 2½ axis machine, control of the motions in the X-Y axes are synchronized and the sprayer's position along the Z axis can be separately controlled without motion synchronization. The 3 axis (X, Y and Z) or even higher axis machines with more synchronized motions enables more complex 3D paths of the spray nozzle and variable spray angles.

In this embodiment, a commercially available NC/CNC system is adapted for the deposition of catalytic and/or polymer materials onto the PEM and/or GDL substrates of the electrodes, thereby facilitating fully automated MEA production with high accuracy and flexibility, with the added cost and reliability benefits of using widely available industrial machines and mature technology. In particular, a CNC machine controller 31, the arm assembly 18 and the table 16 are obtained from a commercially available three-axis CNC machine (not shown), such as a CNC router or a CNC milling machine, and the spraying assembly 18 is retrofitted onto a tool holder of the CNC machine. The power train and spindle of the CNC router/milling machine, useless in this application, can be removed to dramatically simplify the machine and to reduce cost. The relative motions between a tool and a workpiece are controlled by the control computer 14 which is communicative with the CNC machine controller 31, which in turn is communicative with the arm assembly 18. The computer 14 is reprogrammed with tool pass instruction sets for manufacturing the MEA.

This retrofit approach is particularly attractive as a low cost approach to manufacturing the sprayer 10. However, it is to be understood that it is within the scope of the invention to manufacture the sprayer 10 using dedicated components and with original NC programming; such manufacture can provide advantages such as packaging efficiency that is not obtainable when retrofitting an existing NC system.

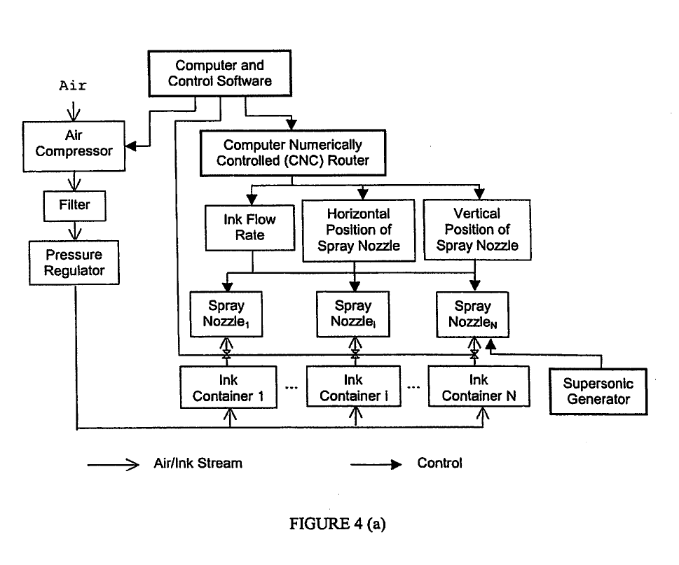

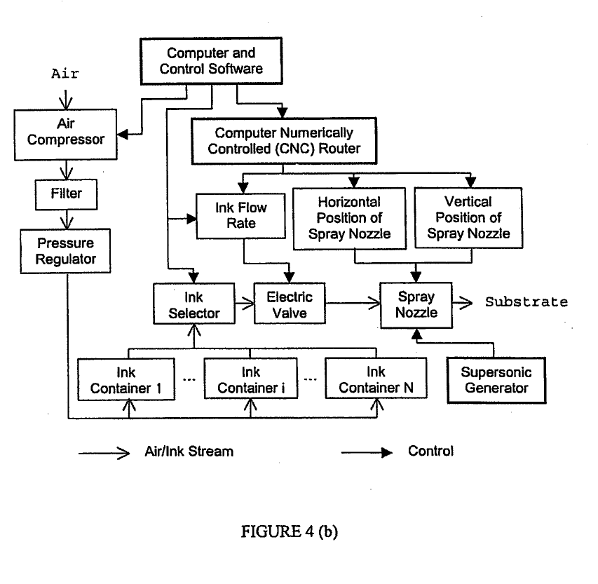

Referring now to FIGS. 4(a) and 5, the sprayer assembly 20 comprises three ultrasonic spray nozzles 22, an ultrasonic signal generator and amplifier 33, ink reservoirs 34 and supply conduits 36 connecting the reservoirs to the nozzles 22. While there are three nozzles shown in this embodiment, it is to be understood that a different number of spray nozzles 22 can be provided at the option of the operator.

Optionally, air jets (not shown) can be mounted in close proximity to the nozzles 22. These air jets are fluidly coupled to an air compressor (not shown) which is controllable to deliver a pressurized air stream from the air jets to shape the ink spray from the nozzles 22. The air compressor can be controlled by the computer 14, or manually controlled.

Each sprayer nozzle 22 has a liquid feed tube 32 that is fluidly coupled at its inlet end to an ink reservoir 34 by a flexible supply conduit 36. The liquid feed tube extends the length of the nozzle 22 and terminates at an atomizing surface outlet 38. Disc-shaped ceramic piezoelectric transducers 40 surround the feed tube 32 and operate as an ultrasonic generator to convert a high frequency electrical signal received at an electrical connector 42 to mechanical vibrations of the same frequency. This motion is then amplified at an atomizing surface 36 through a pair of titanium cylinders (not shown). A transverse standing wave is created along the length of the nozzle 22 and undergoes a step transition and amplification as it travels the length of the nozzle 22. Increasing the vibration amplitude to above critical amplitude causes the capillary waves to collapse and tiny drops of ink material being ejected from the tops of the degenerating waves normal to the atomizing surface.

The soft, low-velocity spray produced by ultrasonic atomizing nozzles 22 have several desirable characteristics that distinguish it from most other spraying techniques and make it a particularly desirable printing technique for catalyst and/or polymer material deposition onto a PEM or GDL substrate:
The amount of overspray is significantly reduced since the drops produced by the ultrasonic atomization technique tend to settle on the substrate rather than bounce off the substrate as other spraying techniques. This saves the costly catalyst material and reduces environmental impact.
There is greater control over the spray since an outside air stream has a larger effect on redirecting the spray.
Since ultrasonic atomization does not depend on forcing the liquid through a small aperture, the liquid outlet can be much larger than a pressure nozzle, reducing the likelihood of becoming clogged by the catalyst ink slurries.

Such ultrasonic nozzles are known in the art; a suitable such nozzle for use with the sprayer 10 is produced by SonoTek Corporation of Milton, N.Y. USA. Each nozzle 22 is fluidly coupled to a dedicated ink reservoir 34 by a separate ink supply conduit 36. Each reservoir 34 contains a different solution of catalyst ink and/or electrolyte ink. Each ink supply conduit 36 is coupled to an air compressor 44 via a control valve 45. The compressor 44 operates to suction ink from the reservoirs 34 and into the supply conduit 36, which then mixes with an air stream to produce a pressurized air/ink stream to the nozzles 22. An air filter 46 and an air pressure regulator 48 are coupled to the air compressor 44 upstream of the control valves 45.

The nozzles 22, compressor 44, control valves 45 and pressure regulator 48 are communicative with the computer 14 which controls the spraying of ink materials onto the GDL or PEM substrates by controlling these devices. Alternatively, one or more of these devices 22, 44, 45, 48 can be manually controlled.

According to an alternative embodiment of the invention and referring to FIG. 4(b), the sprayer 10 can have a single ink spray nozzle 22 that is fluidly coupled by ink tubes 36 to multiple ink reservoirs 34. In this embodiment, an ink selector 50 is fluidly coupled to the ink tube 36 for each reservoir 34, and a single control valve fluidly couples the ink selector to the nozzle 22. The computer 14 is communicative with the ink selector 50 and the control valve 45 to control the spray of ink by the nozzle 22 as well as the switching of ink reservoirs 34 by the ink selector 50.

Selection of PEM/GDL Substrates and Spray Materials

GDL and PEM substrates: The selection of materials for the PEM and GDL substrates 1, 3 depends upon the specific application of the fuel cell. A suitable PEM substrate is the DuPont Nafion® 112 membrane that is made of a perfluorinated polymer with side chains bearing sulfonic acid moieties. A suitable GDL is typically made from a substrate of carbon paper or graphite cloth, which provides the requisite gas permeability, chemical stability and electrical conductivity.

Preparation of the spray ink material: One or more of the ink reservoirs 34 fluidly coupled to each nozzle 22 can contain a catalyst ink solution that is sprayed onto either the GDL or PEM substrate. The solution's composition comprises electrocatalytic material and/or an ionomeric polymer dissolved in a solvent of alcohol and water. The electrocatalytic material can be either a platinum (Pt) or platinum-ruthenium (Pt—Ru) electrocatalyst-loaded carbon powder. Platinum and platinum-ruthenium are among the most active materials for oxygen reduction and for hydrogen/methanol oxidation, having the required stability to operate in the acidic environment of the PEM fuel cell and the ability to avoid CO poisoning. The electrocatalyst-loaded carbon powders are dissolved in the solvent to form the key ingredient of the catalyst ink. A suitable ionomeric polymer such as Nafion® can be added to one or more of the catalyst ink solutions. One suitable catalyst ink solution composition can be 5% Nafion®, 40% Pt loaded carbon powder, and the balance being a mixed alcohol and water solvent. The solution can optionally include water repellent agents, such as Teflon®. Additional catalyst ink solutions can be provided with different ionomeric polymer and electro-catalyst proportions within the solvent. These catalytic solutions of differing compositions can be stored in multiple ink reservoirs 34, such as the three shown in the Figures. Each reservoir 34 can serve as the source of ink material for a sub-layer sprayed by the sprayer 10 onto the substrate; by spraying multiple sub-layers wherein each sprayed sub-layer is from a different reservoir, a catalytic layer is created having a compositionally graded microstructure in its thickness dimension.

Additionally or alternatively, one of the ink reservoirs 34 can contain an electrolyte ink solution that is sprayed onto a gas diffusion electrode (GDE), i.e. the GDL 3 coated with the catalytic layer 2. The solution's composition comprises an ionomeric polymer dissolved in a solvent of alcohol and water; a suitable ionomeric polymer is Nafion®.

According to another embodiment of the invention, the ink reservoirs 34 can contain pure solutions of an ionomeric polymer (e.g. Nafion®), carbon (e.g. carbon powder), electro-catalyst (e.g. Pt loaded carbon powder), and/or water repelling agents, instead of multiple reservoirs 34 each containing different compositions of electro-catalyst ink solutions. In this embodiment, either the multiple nozzle sprayer 10 or the single nozzle sprayer (not shown) can be fluidly coupled to each of these reservoirs 34. Using the single nozzle sprayer as an example, the ink selector can blend the ink solutions from two or more of these reservoirs to create the desired composition of the ink spray that is emitted from the spray nozzle 22. The ink spray composition can be altered by the sprayer 10 while the catalyst layer 2 is being formed, to create a compositionally graded catalyst layer 2. In particular, the catalyst layer 2 would have a graduated transition from Nafion at the interface with the PEM, to carbon/graphite at the interface with the GDL.

Controlling Sprayer Operation

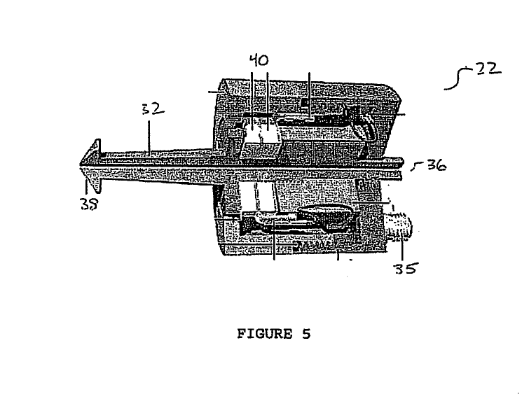

Referring to FIGS. 6(a) and (b), the ink solutions are sprayed by the sprayer 10 onto the GDL or PEM substrates to form the catalyst and/or electrolyte layers 2, 1 for a multiple-layered MEA structure; multiple passes of the sprayer 10 over the substrate using ink solutions of different compositions can be performed to produce a catalytic layer 2 having a varying composition in its three dimensions. The computer 14 is programmed to perform such a spraying operation by controlling the switching or mixing among different ink materials by controlling the control valve(s) 45, the intensity and shape of the ultrasonic spray by controlling the spray nozzle(s) 22, and the spray pattern on the substrate by controlling the motion of the arm assembly 18. Optionally, one or more of these functions can be controlled manually by an operator.

The control of the spray process starts from an analysis of suitable flow fields for the fuel cell gas delivery plates, the consumption of oxidant air and fuel gas of the fuel cell, and the amount of expected water in the gas flow streams either by humidification or as by-product during fuel cell operation. These factors determine the preferred amount and distribution of electrocatalysts, ionomeric polymer and water repellent agents at different areas of the electrode. Such an analysis is known in the art and thus not described in detail here.

The geometry of the substrate is the first factor to consider when programming the CNC tool path of the spray nozzles 22. A CNC spray nozzle tool path is first created to cover the entire active area of the GDL/PEM, using an automated tool path generation program from a CAD/CAM system and/or a dedicated tool path generation program as is known in the art. Manual tool path programming based on the flowfield geometry is another alternative. Such a tool path can create a catalyst later 2 on the GDL 3 or PEM 1 having a uniform layer thickness and composition by passing the nozzle 22 over the substrate in one or more passes using a single catalytic ink solution at a constant arm assembly speed and discharging ink spray at a constant flow rate and spray pattern.

A more complex catalytic layer 2 can be formed by having the computer 14 vary certain characteristics of the sprayer 10 operation. For example, the spray nozzle tool path can be programmed to vary the speed and direction of the arm assembly 18 over the substrate, to vary the ink solution flow rates out of the nozzle, to vary the spray pattern applied to the substrate, and to change the ink solution composition between sub-layers. Also, the spray nozzle tool path can be programmed to create a catalyst layer that has a composition that varies along the flow path of the reactants in the fuel cell; for example, the sprayer can deposit more electrocatalyst material in the part of the catalyst layer 2 further downstream of the oxidant flow field since there the amount of oxidant tends to decrease towards the downstream end of the flow field. Additionally, the sprayer 10 can deposit more water repellant material at the downstream part of the flow path since there tends to be more water buildup towards the downstream end of the flow field.

When using a sprayer 10 comprising a sprayer assembly 20 retrofit onto an existing CNC machine, the computer 13 is used as the interface to program the CNC machine's controller to control the movement of the arm assembly 18. Furthermore, the computer 13 can be programmed to directly control the operation of the sprayer assembly 18.

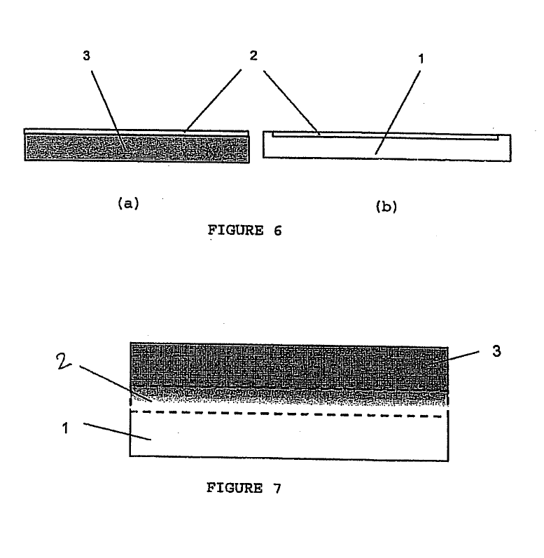

Referring to FIG. 6(a) some or the entire catalytic layer 2 can be formed on the GDL by spraying the catalytic ink solution by one or more passes of the sprayer nozzle(s) 22 over the target substrate. Multiple pass spraying can be carried out to create multiple sub-layers of the catalytic layer 2, wherein between passes, an air stream can be blown onto the sub-layers to dry them. The repeated spray passes can use the same or different nozzle trajectories that cover the same or slightly different areas of the substrate. Different sub-layers can be sprayed by spraying ink from different ink reservoirs containing different ink compositions in each sub-layer pass. This enables the formation a three-phase and 3-D catalyst layer structure to be built as shown in FIG. 7. Spray using different ink materials can be accomplished by the sprayer 10 having multiple spray nozzles 22 wherein each nozzle 22 is coupled to a different ink reservoir (FIG. 4(a) embodiment), or alternatively, by the sprayer 10 having a single nozzle 22, wherein multiple ink reservoirs are coupled by ink tubes 36 to a single ultrasonic spray nozzle 22 and switchable by an ink selector 50 (FIG. 4(b) embodiment).

Referring to FIG. 6(b), some or all of the catalytic later 2 can be formed on the PEM by spraying catalytic ink solution by one or more passes of the sprayer nozzle(s) 22 over the target substrate. Optionally and before application of the catalytic ink solution, the mixed electrolyte/catalytic ink solution can be first sprayed onto the PEM to create one or more sub-layers of the catalytic layer 2.

Referring to FIG. 7, after the catalytic layer 2 has been applied to one or both of the GDL 3 or PEM 1 substrates, the coated GDL 3 and PEM 1 can be assembled together to form the MEA. Appropriate drying, bonding and compressing processes are needed to produce a MEA with good performance; such MEA assembly techniques are well known in the art and are beyond the scope of this disclosure.

In summary, the formation of the catalyst layer 2 can be carried out by controlled spray on a substrate that can be either the GDL 3, or the PEM 1. The ink materials deposited by the ultrasonic sprayer 10 can contain preferred catalyst particles, carbon or graphite power coated with finer catalyst particles, electrolyte material, or combinations thereof. Multiple layer material deposition builds up a catalyst layer 2 with a certain thickness. When different materials and/or different compositions of materials are used for different deposition layers, a multiple phase, three-dimensional (3D) structure can be created, as shown in FIG. 7. This structure 2 supports a graduate transition from the porous carbon/graphite GDL 3 to the solid polymer electrolyte material 1 with embedded catalyst, to obtain improved fuel cell performance.

### EXAMPLE

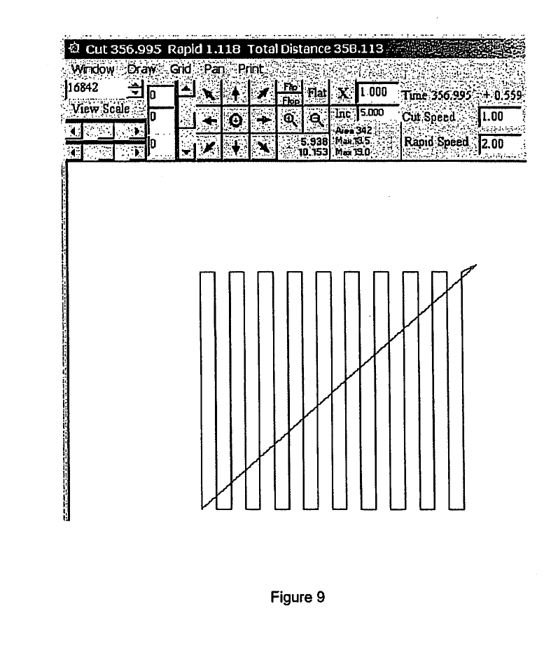

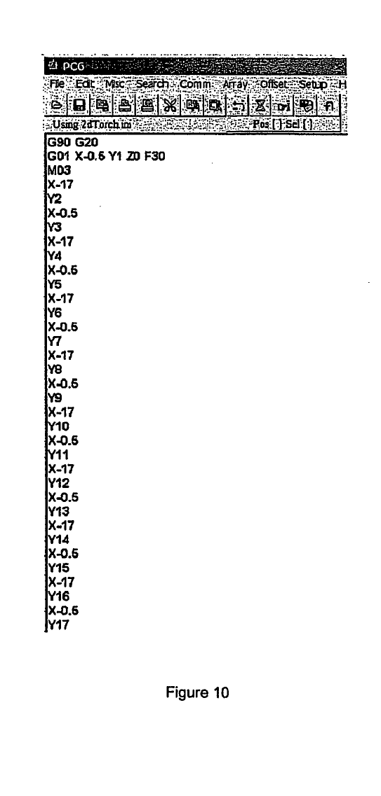

As an example, production of the catalytic layer 2 by spraying catalytic ink solution onto the GDL 3 using a 2½ axis CNC router retrofitted with the sprayer assembly 20 is illustrated in FIGS. 9 and 10. The geometry of the spray nozzle path of the sprayer 10 for one spray pass are illustrated in FIG. 9. A G-code program is used to control the travel of the spray nozzle path and the nozzle operation of the CNC ultrasonic sprayer is shown in FIG. 10.

Motions in the X-Y axes are synchronized to create an even coverage of the substrate. Different sub-layers are sprayed using different Z axis values and nozzle feederates to control the thickness of the deposition. The following parameters are used for this layer's spray printing:
Feedrate of the nozzle: 30 in/min
Ink flow rate: 2.8 mL/min
Power of ultrasonic: 3W
Spraying height (Z value): 3 inches
Hot plate temperature: 70° C.

Conclusions

The technique and process provide automation and flexibility to a very complex and performance sensitive catalyst deposition operation, allowing key fuel cell MEA performance influencing parameters, such as the thickness, evenness, deposit pattern and porosity of the catalytic layer to be controlled by easy-to-change computer programs that drive the NC machine. The process controls many key fuel cell performance influencing parameters of the MEA, such as:
Catalytic Layer Thickness
   The thickness of the catalytic layer is controlled by the traveling speed of the spraying nozzle, the distance between the nozzle to the substrate, and the composition and flowrate of the ink. This thickness directly influences the needed pressures of the oxidant air and fuel gas, as well as the performance of the fuel cell.
Catalytic Layer Evenness
   Even distribution or distribution according to designed pattern directly relate to the performance of the fuel cell and the consumed amount of costly catalyst material. Overlapping and spray pattern control is carried out through mathematical modeling and a precise spray trajectory control program.
Catalyst Loading
   The loading with catalyst can be controlled varying the viscosity of the catalytic ink in accordance with the traveling speed of the spraying nozzle, the distance between the nozzle to the substrate, and the ink flow rate.
Precise Control on the Location and Amount of Catalyst Deposition
   The CNC spray paths enable catalyst to be selectively deposited only onto the active area of the fuel cell, avoiding the waste of the costly catalyst material, such as at the edge of the fuel cell and the manifold holes.

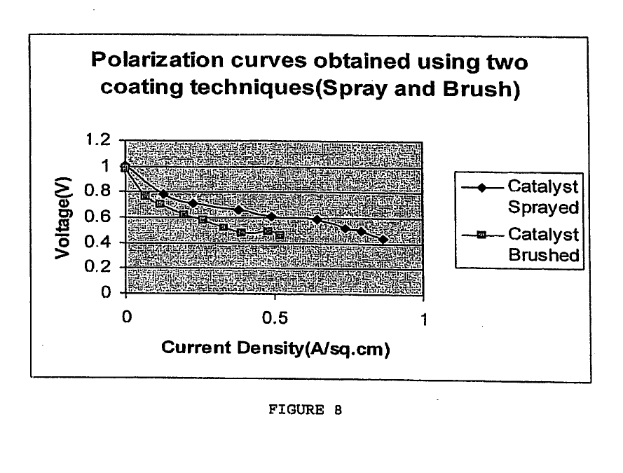

The ability to precisely and dynamically control the feed-rate (or traveling speed) of the spray nozzle, and/or the ink composition allows the amount of deposited catalyst to vary following the gas flow channels of the fuel cell plates (e.g. oxidant air and fuel hydrogen). By adjusting the catalyst content along the flow field, the current density variation across the fuel cell plate caused by oxygen depletion, gas humidification, and flooding, can be counterbalanced, thereby ensuring an evenly distributed power generating capability with improved cell performance and lifetime.
A 3D catalytic layer structure
   By applying different ink compositions for the different passes of the sprayer 10, a three dimensional structure of the catalytic layer 2 can be built, allowing a smooth transition from PEM to GDL materials. For instance, as illustrated in FIG. 7, more Nafion material is applied in the catalytic layer close to the PEM, and more carbon material is applied in the catalytic layer close the GDL, form a catalytic layer with varying material composition in the thickness direction. The fusion of the base material and the fine control on the location of the catalyst will lead to improved fuel cell performance, as reported in the literature and verified by experiment (FIG. 8). The sprayer 10 provides a low-cost and effective 3D catalytic layer formation method.
Catalytic Layer Porosity
   By setting the spraying characteristics, such as the size of the droplets of the sprayed ink material, of the ultrasonic spraying, and/or the use of appropriate pore forming substances in the catalytic ink, precise control on the porosity of the catalyst layer can be achieved.

The sprayer 10 not only automates the catalyst deposition operation during MEA production, it also produces the MEA of a PEM fuel cell with superior performance due to the improved accuracy and consistency of the deposition, as well as a preferred deposit pattern and 3D catalyst layer structure, as shown in FIG. 8. Around twenty percent higher cell voltage is observed from the PEM fuel cell that having an MEA made by the sprayer 10, compared to a PEM fuel cell made using a traditional, hand-painted MEA. In addition, the invented process and apparatus have the following advantages from the perspective of manufacturing and economics:
Full automation of the catalyst deposition process with well controlled accuracy, providing flexibility on the amount of the deposition at different areas of the substrates, using low-cost and general purpose NC/CNC machines or routers.
Construction of a three dimensional active catalyst structure at the interface between the PEM and the electrodes, through well controlled, multiple-layer spraying using multiple ink materials and spray nozzles mounted on the NC/CNC machines or routers.
Use of Computer-Aided Design and Manufacturing (CAD/CAM) techniques and software tools to automatically generate the spray paths for the deposition of the catalyst and electrolyte materials.
Total control on the locations of points on the spray paths, the traveling speed of the spray nozzle, the distance between the nozzle and sprayed substrate, the flow rate of the sprayed material and the deposited amount, as well as the use and switch of single or multiple sprayed materials through standard computer instructions and CNC machine/router.
The automation of the process, which supports a quick change of catalyst deposition pattern for different fuel cells and different applications as well as different fuel cell cross section size and shape, with a simple change of the tool path program that runs the NC/CNC machine and router.

While the preferred embodiment of the invention has been illustrated and described, it will be appreciated that various changes can be made therein without departing from the scope and spirit of the invention.

1. An apparatus for manufacturing one or more fuel cell membrane electrode assembly (MEA) components, comprising:
(a) a table for supporting one or more MEA components;
(b) a motorized arm assembly movable relative to the table;
(c) an ultrasonic sprayer assembly connected to the arm assembly and in fluid communication with at least one ink reservoir containing catalyst or electrolyte ink solution; and
(d) a controller communicative with the arm and sprayer assemblies and programmable to move the arm assembly along a programmed tool path and spray ink solution from the sprayer assembly onto a substrate supported by the table.

2. An apparatus as claimed in claim 1 wherein the sprayer assembly comprises multiple discharge nozzles, with each nozzle being fluidly coupled to at least one dedicated ink reservoir.

3. An apparatus as claimed in claim 1 wherein the sprayer assembly comprises a single discharge nozzle coupled to multiple ink reservoirs by a switching valve that is controllable to direct ink solution from one or more reservoirs to the nozzles.

4. An apparatus as claimed in claim 1 wherein the controller is programmable to vary during spraying, one or more of a spray composition, pattern, and intensity, and, one or more of the sprayer assembly location and speed over the substrate.

5. An apparatus as claimed in claim 4 wherein the apparatus includes multiple ink reservoirs with a first ink reservoir containing an electro-catalyst ink solution, a second ink reservoir containing an ionomeric polymer ink solution, and a third ink reservoir containing a carbon ink solution, and wherein the controller is programmed to control the spray composition by controlling the flow of each ink solution to the sprayer assembly.

6. An apparatus as claimed in claim 4 wherein the sprayer assembly further comprises a pump coupled to each ink reservoir and wherein the controller is communicative with the pump to control the spray intensity by controlling the pump's feed rate.

7. An apparatus as claimed in claim 4 wherein the sprayer assembly further comprises air jets and the controller is communicative with the air jets to direct the air jets to shape the spray pattern.

8. An apparatus as claimed in claim 4 wherein the arm assembly includes multiple tracks and arms movably coupled to the tracks such that the sprayer assembly is independently movable relative to the length, width and height of the table, and wherein the controller is communicative with the arm assembly to control the sprayer assembly location and speed over the length, width and height of substrate.

9. An apparatus as claimed in claim 4 wherein the controller is programmed to control at least one of the spray composition, spray intensity, spray pattern, sprayer movement, and sprayer speed during spraying to form a catalytic layer having a compositionally graded depth with an increasing amount of carbon material towards a gas-diffusion layer interface portion of the catalytic layer, or, an increasing amount of ionomeric-polymer material towards an electrolyte interface portion of the catalytic layer.

10. An apparatus as claimed in claim 9 wherein the controller is programmed to control at least one of the spray composition, spray intensity, spray pattern, sprayer movement, and sprayer speed to form a compositionally graded catalytic layer with a greater amount of electrocatalyst or water repellent material at a downstream end of a fuel cell flow field than at an upstream end of the fuel cell flow field.

11. An apparatus as claimed in claim 1 wherein the controller is programmed to apply multiple spray passes onto a gas diffusion layer substrate or a proton exchange membrane substrate, and wherein at least two of the spray passes spray catalytic ink solutions having different compositions, thereby creating a catalytic layer with a compositionally graded depth.

12. An apparatus as claimed 1 further comprising a heating element in the vicinity of the table, for heating the substrate supported thereon.

13. An apparatus as claimed in claim 1 further comprising an enclosure surrounding the arm and sprayer assemblies, for impeding diffusion of fumes emitted from the ink solution.

14. An apparatus as claimed in claim 13 further comprising a heating element located in the vicinity of the enclosure, for heating the inside of the enclosure.

15. An apparatus for manufacturing one or more fuel cell membrane electrode assembly (MEA) components, comprising:
(a) a CNC machine having a table, a motorized arm assembly movable relative to the table, and a programmable controller communicative with and for controlling the motion of the arm assembly; and
(b) an ultrasonic sprayer assembly connected to the arm assembly and in fluid communication with at least one ink reservoir containing catalytic or electrolyte ink solution;
the controller also being communicative with the sprayer assembly and programmable to move the arm assembly along a programmed tool path and spray ink solution from the sprayer assembly onto a substrate supported by the table.

16. An apparatus as claimed in claim 15 wherein the CNC machine is selected from the group of a CNC router and a CNC milling machine.
